(19) United States
(12) Patent Application Publication
(10) Pub. No.: US 2026/0247513 A1
(43) Pub. Date: Aug. 20, 2026

(54) A CONTROLLER FOR SENSING IN AN ENVIRONMENT VIA A FIRST AND SECOND SENSING SYSTEM AND A METHOD THEREOF

(71) Applicant: SIGNIFY HOLDING B.V., EINDHOVEN (NL)

(72) Inventors: PETER DEIXLER, ARLINGTON, MA (US); MUHAMMAD MOHSIN SIRAJ, EINDHOVEN (NL)

(21) Appl. No.: 19/164,726

(22) PCT Filed: Mar. 11, 2024
(86) PCT No.: PCT/EP2024/056362

§ 371 Date: Sep. 12, 2025

Related U.S. Application Data
(60) Provisional application No. 63/452,461, filed on Mar. 16, 2023.

(30) Foreign Application Priority Data
Mar. 28, 2023 (EP) 23164562.3

(51) Int. Cl. H05B 47/115; G05B 15/02

(52) U.S. Cl. CPC H05B 47/115; G05B 15/02; G05B 2219/2642

(57) ABSTRACT

A method of sensing in an environment via a first and a second sensing system, wherein a first controller and a second controller are arranged for controlling the first and the second sensing system respectively, and wherein the first sensing system is of a different type than the second sensing system, and have at least a partially overlapping sensing range with the second sensing system, wherein the first controller is further arranged for controlling a first actuation system which can affect, at least in a subzone of the environment, the sensing from the second sensing system, wherein the method comprises: receiving, at the first controller, a request for an interaction from the second controller, wherein the request comprises adjusting the actuation of the first actuation system to minimize the effect of the first actuation system on the sensing of the second sensing system, assigning a priority value to the received request indicative of a level of priority of the received request, determining whether to accept the request of adjusting the actuation based on the assigned priority value.

### FIELD OF THE INVENTION

The invention relates to a method for sensing in an environment via a first and a second sensing system. The invention further relates to a controller, a system, and a computer program product for sensing in an environment via a first and a second sensing system.

### BACKGROUND

A smart home system is arranged for monitoring and/or controlling home attributes such as lighting, climate, entertainment systems, and appliances. A smart system comprises functions of sensing, actuation and/or control in order to describe and analyze a situation in an environment. The sensing enables the system to ‘see’ the environment, machine learning/AI algorithms bring the ‘intelligence to think/decide based on what is seen’ and the actuating elements provide the means to impact the environment based on the ‘smart’ decisions taking by the machine learning/AI algorithm.

When connected with the Internet, smart (home) devices are an important constituent of the Internet of Things (IoT). Although the convention of smart ‘home’ system is used, the concept of connected/smart systems are equally used in other non-home environments such as offices, retail, hospitals, public squares, sport stadiums etc.

### SUMMARY OF THE INVENTION

The inventors have realized that the interactions between different smart systems in a multi-smart systems environment are constantly increasing and evolving. Due to these ever-increasing interactions, sensing and actuation of different systems are interconnected and may (positively or negatively) affect each other. Since, these smart systems are aimed at improving user experience in the environment, the sensing and the actuation (which is mostly based on context awareness insights derived from the sensing data) to provide optimal user experience in a multi-smart systems environment becomes challenging.

It is therefore an object of the present invention to improve sensing in view of the interaction with other actuation/sensing systems in a multi-smart systems environment.

According to a first aspect, the object is achieved by a method of sensing in an environment via a first and a second sensing system, wherein a first controller and a second controller are arranged for controlling the first and the second sensing system respectively, and wherein the first sensing system is of a different type than the second sensing system, and have at least a partially overlapping sensing range with the second sensing system, wherein the first controller is further arranged for controlling a first actuation system which can affect, at least in a subzone of the environment, the sensing from the second sensing system, wherein the method comprises: receiving, at the first controller, a request for an interaction from the second controller, wherein the request comprises adjusting the actuation of the first actuation system to minimize the effect of the first actuation system on the sensing of the second sensing system, assigning a priority value to the received request indicative of a level of priority of the received request, determining whether to accept the request of adjusting the actuation based on the assigned priority value.

The method relates to sensing in an environment. The environment may be an indoor environment such as a home, a hotel, an elderly care home, a hospital, an office, a grocery/shopping store, a casino etc., or an outdoor environment such as a street, a parking lot, a public square, a city beautification system, a stadium etc.

The sensing is performed via a first and a second sensing system wherein a first controller and a second controller are arranged for controlling the first and the second sensing system respectively. The sensing system may comprise but not limited to presence sensors, light sensors, humidity sensors, air quality sensor (CO, pollutants, etc.), a motion sensor, occupancy sensor (infrared (IR), passive infrared (PIR), ultrasonic, etc.), thermal sensor, an electromagnetic sensor (e.g., radiofrequency-based sensing, RADAR sensing, WiFi Doppler), a structured light sensor (e.g. ToF), a LiDAR sensor, an acoustic sensor, air quality sensor (CO, pollutants, etc.), video (security camera, etc.), audio (microphone, etc.) etc.

The first sensing system is of a different type than the second sensing system and have at least a partially overlapping sensing range with the second sensing system. In an example, the different sensor type comprises different sensing mechanism for the same sensing application. For instance, the first sensing system is related to presence sensing via vision-based sensing and the second sensing system is related to the same application of presence sensing but via a different sensing mechanism such as radiofrequency-based sensing. In another example, the first sensing system is related to gesture detection sensing via radar sensing and the second sensing system is related to the same application of gesture sensing but via a different sensing mechanism such as WiFi radiofrequency-based sensing. In another example, the heat emitted from the phase-cut dimmer or a high-power lighting device due to its current lighting task may negatively affect the sensing performance of a PIR or thermopile sensor. In another example, the different sensor type comprises sensing with a modified set of parameters for the same sensing mechanism. Yet in another example, the different sensor type may comprise different sensing mechanism for different sensing applications, such as presence sensing and temperature sensing in an environment.

The first controller is further arranged for controlling a first actuation system. The first actuation system may comprise attributes such as lighting, climate, entertainment systems, screens, beamers, TV and appliances, e.g., HVAC system, connected lighting system, audio/video system, windows blinds etc. The second controller may be arranged for controlling a second actuation system. In an example, the first actuation system and the first sensing system are co-located. In another example, the first actuation system and the first sensing system are comprised in the same device or in the same housing, e.g., the actuation and the sensing are performed by the same device.

The first actuation system can affect, at least in a subzone of the environment, the sensing from the second sensing system. For instance, a lighting actuation system (e.g., the lighting devices arranged for illuminating the environment) may affect a vision-based sensing system, for instance camera-based sensing system. The effect of the actuation on the sensing may be limited to a subzone of the environment or extended to the complete environment based on the field of view of the sensing system and the range or field of view of the actuation system. The effect may be a negative effect such that the actuation hampers the sensing abilities of the sensing system or a positive effect such that the actuation helps in improving the sensing abilities of the sensing system. The subzone of the environment may (at least partially) overlap with the at least partially overlapping sensing range.

Similarly, the EMI of the lights or a lighting control device can disturb the electronics of a nearby radar sensor. For instance, WiFi-controlled phase-cut dimmer mounted in a 2-Gang wall box arrangement right next to a flush-mounted non-lighting UI with radar sensing may cause EMI disturbances to the radar sensing.

The method comprises receiving, at the first controller, a request for an interaction with the second controller, wherein the request comprises adjusting the actuation of the first actuation system to minimize the effect of the first actuation system on the sensing of the second sensing system. The request may be received from the second controller and/or (directly) from the user. The user may use the second controller to send the request or use a user's device such as mobile phone, tablet etc. to send the request. The second controller may be arranged for determining the (negative) effect of the first actuation system and then the first controller may receive a request from the second controller to adjust the actuation such that the negative effect of the actuation may be minimized/removed. The second controller may ask for the adaptation of the actuation is a specific range of the subzone or in the complete region of interference.

The method further comprises assigning a priority value to the received request indicative of a level of priority of the received request. Since, the method further comprises determining whether to accept the request of adjusting the actuation based on the assigned priority value, a prioritize approach is used to minimize the (negative) effect of actuation on the sensing system (e.g., the disturbances suffered by the non-lighting sensing system due to the actuation of the illumination-function of the lighting-based sensing system) therefore improving the sensing in view of the interaction with other actuation/sensing systems in a multi-smart systems environment.

If the determination results in an acceptance of the request, the method may further comprise adjusting the actuation of the first actuation system based on the request.

The adjustment is performed such that the effect of the first actuation system on the sensing of the second sensing system is reduced. In an example, the adjustment is determined by the first controller based on the request and/or by the second controller. Therefore, by adjusting the actuation, the sensing is further improved in view of the interaction with other actuation/sensing systems in a multi-smart systems environment.

If the determination results in a rejection of the request, the method may further comprise requesting the second controller to hand over, at least partially, a sensing task of the second sensing system to the first sensing system in the at least partially overlapping sensing range.

The first controller may decide to not accept the request of adjustment from the second controller, e.g., in a situation when the actuation is considered more or at least equally important compared to the sensing by the second sensing system. In such a situation, the first controller may offer the second controller to hand over the sensing to the first sensing system controlled by the first controller. The hand over comprises taken over the sensing from the second sensing system. In this example, the first and the second sensing system comprise the same sensing application but with different sensing mechanism (e.g., presence sensing via vision-based sensing and presence sensing via radiofrequency-based sensing; or gesture detection via radar sensing and gesture detection via radiofrequency-based sensing). Since, the sensing in the subzone where the second sensing system is impacted by actuation is taken over by the first sensing system, the overall sensing in the environment is improved.

If the determination results in a rejection of the request, the method may further comprise requesting the second controller to perform a joint sensing in the at least partially overlapping sensing range.

Additionally, or alternatively to handing over the sensing, the first controller may ask the second controller to perform a joint sensing in the at least partially overlapping sensing range. The final sensing outcome for the sensing event may comprise a fusion of the sensing outcomes of the both the sensing system.

The first controller may be arranged for controlling a lighting system comprising at least one lighting device for providing illumination in the environment and a radiofrequency-based sensing, and wherein the second controller may be arranged for controlling a vision-based sensing system, wherein the radiofrequency-based sensing has at least a partially overlapping sensing range with the vision-based sensing, and wherein the lighting illumination can affect the vision-based sensing system at least in a subzone of the environment.

In a further developed embodiment, the actuation of the lighting device may be temporarily reduced to minimize the disturbance of the second sensing system. For instance, if the radar or vision sensor is tasked for occasionally detecting the sitting body posture of the user, it may adjust the dynamic lighting recipe of a wall washer such that occasionally the light output and hence emitted EMI is low and hence the sensing performance of the radar sensor of the other sensing system is maximized.

The first actuation system may comprise a lighting system and the first controller may be arranged for controlling the lighting system. The first sensing system may comprise a radiofrequency-based sensing system. A radio frequency-based sensing is a sensing mechanism involving wireless transceivers (or transmitters/receivers) arranged for transmitting and receiving radiofrequency (RF) signals. These RF signals, which may also be used for radio communication, when passing through a sensing volume, are affected by presence/movement of a person within the sensing volume e.g., via reflection, absorption, scattering etc. The radiofrequency-based sensing uses such deviations of radiofrequency signals to infer presence/motion of the person. Radiofrequency-based sensing also extends to other applications such as location detection, fall detection, gesture detection, vital signs detection etc. which are also based on how radiofrequency signals are affected in the sensing volume. The radio frequency-based sensing may further comprise radar-based sensing. In an example, the first sensing system may comprise a time-of-flight (ToF) sensing system.

The lighting system may comprise at least one lighting device for providing illumination in the environment. In an example, the lighting system is a connected lighting system such that the lighting devices and/or the other devices in the lighting systems such as lighting controllers, flush-mounted phase-cut dimmers, adapters, smart sockets etc. are equipped with wireless transceivers (or transmitter/receiver) for communicating with each other and/or with the first controller. In this example, the RF signals transmitted between the devices of the lighting system (such as the at least one lighting device) may be used for radiofrequency-based sensing. In this example, the actuation system and the sensing system are co-located, e.g., within the same lighting device.

The second sensing system may be a vision-based sensing system, such as a camera-based sensing system. The radiofrequency-based sensing may have at least a partially overlapping sensing range with the vision-based sensing, and wherein the lighting illumination can affect the vision-based sensing system at least in a subzone of the environment.

The method may further comprise assigning priority value based on one or more of: the request of interaction, a characteristic of the requested interaction with the second controller, a characteristic of the second controller, a number and/or type of the sensing devices for the second sensing system.

The method may further comprise assigning a trustworthiness value indicative of a level of trustworthiness of the second controller, and wherein priority value may be assigned based on the trustworthiness value.

The trustworthiness value may be determined at least based on one or more of a previous interaction with the first controller, a security certificate of the second controller etc. The priority value may be advantageously assigned based on the trustworthiness value, e.g., a higher value may be assigned to a known, trustworthy second controller compared to an unknown, dubious second controller.

The method may further comprise assigning priority value based on the sensing tasks and/or the sensing outcome of the second sensing system. For example, the sensing tasks which are also valuable for the actuation and/or sensing of the first controller may be assigned a higher priority value. Additionally, or alternatively, the sensing tasks which are critical to user's need/health such as sensing related to health parameters for instance fall detection, vital sign detection, gait analysis etc. of a user may be assigned higher priority value. Even for the same sensing tasks, the sensing outcome may be assigned different sensing priority values, e.g., a fall detection event may be assigned a higher priority value compared to no fall, or near fall event.

The method may further comprise assigning priority value based on an environment related contextual information. For example, the contextual information may comprise type of the environment such as indoor environment, outdoor environment, objects in the environment, if the second controller with the sensing system is placed in a particular zone of the environment, size of the environment etc.

The method may further comprise determining whether to accept the request of adjusting the actuation further based on a user's past interaction or preference with the first and the second controller.

For example, because of privacy-related issues, a user may prefer radiofrequency-based sensing over vision-based sensing, or the user has experienced many false positives with a sensing system compared to the other sensing system or the user prefers from a health perspective the WiFi sensing system (using only the WiFi bands) compared to the other sensing system (radar system using 60 GHz mm-wave bands). In such scenario, a user may input his/her preference or indicate any (good/bad) past interaction.

The determination of whether to accept the request of adjusting the actuation may be further based on sensing performance of the first and the second sensing system at least in the subzone of the environment.

Sensing performance, e.g., less false positives/negatives, higher resolution, better range, health preferences etc. are critical parameters which may be included in the criteria for determining whether to accept the request of adjusting the actuation of the first actuation system. For example, if the sensing performance of the first sensing system is poor, the first controller will adjust the actuation of the first actuation system to let the second sensing system continue sensing without any performance degradation. Alternatively, if the sensing performance of the second sensing system is poor, the first sensing system via the first controller may request the second controller to either hand over the sensing task or perform joint sensing.

In this example, the sensing performance may be evaluated based on number of sensing nodes, historical performance of the first and the second sensing system, layout of the subzone of the environment, physical objects in the subzone of the environment, sensing interference in the subzone of the environment.

According to a second aspect, the object is achieved by a controller for sensing in an environment via a first and a second sensing system, wherein a first controller and a second controller are arranged for controlling the first and the second sensing system respectively, and wherein the first sensing system is of a different type than the second sensing system, and have at least a partially overlapping sensing range with the second sensing system, wherein the first controller is further arranged for controlling a first actuation system which affects, at least in a subzone of the environment, the sensing from the second sensing system, wherein the controller comprises a processor arranged for executing the steps (or at least control the execution) of the method according to the first aspect.

According to a third aspect, the object is achieved by a system for sensing in an environment via a first and a second sensing system, wherein a first controller and a second controller is arranged for controlling the first and the second sensing system respectively, and wherein the first sensing system is of a different type than the second sensing system, and have at least a partially overlapping sensing range with the second sensing system, wherein the first controller is further arranged for controlling a first actuation system which affects, at least in a subzone of the environment, the sensing from the second sensing system, wherein the system comprises at least the first controller, and a controller according to the second aspect.

According to a fourth aspect, the object is achieved by a computer program product comprising instructions which, when the program is executed by a computer, cause the computer to carry out the steps of the method of the first aspect. The object may be further achieved by a computer program product comprising instructions which, when the program is executed by the processor of the controller, cause the processor to carry out the steps of the method of the first aspect.

It should be understood that the computer program product, the controller, and the system may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for sensing in an environment via a first and a second sensing system,

FIG. 2 shows schematically and exemplary an embodiment of a controller for sensing in an environment via a first and a second sensing system,

FIG. 3 shows schematically and exemplary a flowchart illustrating an embodiment of a method for sensing in an environment via a first and a second sensing system.

All the figures are schematic, not necessarily to scale, and generally only show parts which are necessary in order to elucidate the invention, wherein other parts may be omitted or merely suggested.

### DETAILED DESCRIPTION OF EMBODIMENTS

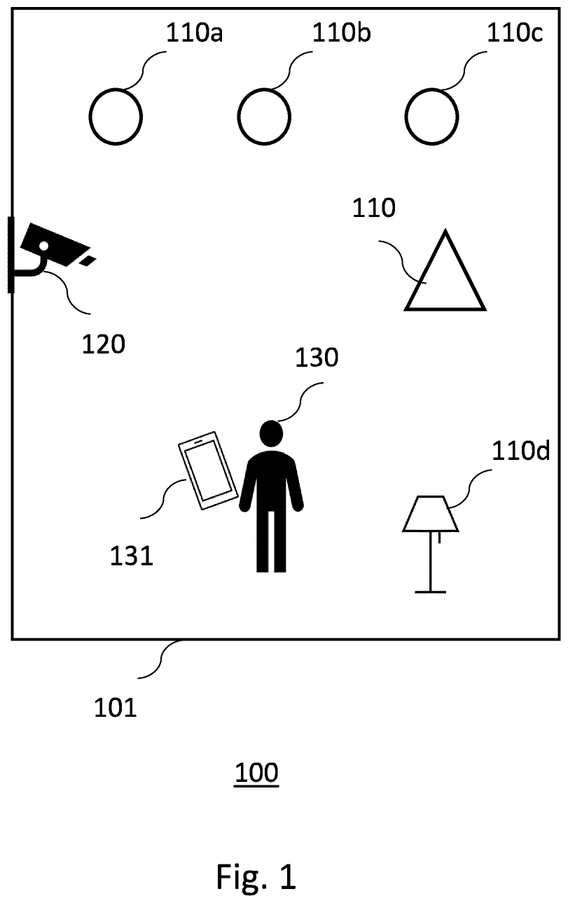

FIG. 1 shows schematically and exemplary an embodiment of a system 100 for sensing in an environment 101 via a first 110a-d and a second sensing system 120. In the exemplary figure, the first sensing system comprises a radiofrequency-based sensing system performed by the lighting devices 110a-d. In an example, radiofrequency signals communicated among (connected) lighting devices 110a-e may be used for radiofrequency-based sensing for presence, motion and for other sensing applications. In another example, RADAR sensors (24 GHz radar, UWB radar, 60 GHz radar, WiFi Doppler radar) may be integrated in the lighting devices 110a-e for presence, motion of the user 130 in the environment 101, and for other sensing applications in the environment 101. In another example, time of flight sensors (TOF) may be integrated in the lighting devices 110a-e. These sensing modalities may be present jointly or separately in the lighting devices 110a-e.

In an example, a user device 131 such as a mobile phone, a tablet etc. may be a part of the sensing system. The other sensing applications may be related to healthcare applications such as fall detection, vital sign monitoring etc. In another example, other sensor types such as PIR, acoustic sensor, vibration sensor etc. are embedded in the lighting devices 110a-d. In an example, the actuation of the lighting devices 110a-e may be based on the monitored sensing tasks.

A lighting device 110a-d is a device or structure arranged to emit light suitable for illuminating an environment 101, providing or substantially contributing to the illumination on a scale adequate for that purpose. A lighting device 110a-d comprises at least one light source or lamp, such as an LED-based lamp, gas-discharge lamp or filament bulb, etc., plus (or optionally) any associated support, casing or other such housing. Each of the lighting devices 110a-d may take any of a variety of forms, e.g., a ceiling mounted luminaire, a wall-mounted luminaire, a wall washer, or a free-standing luminaire (and the luminaires need not necessarily all be of the same type). In this exemplary figure, the lighting devices 110a-c are ceiling luminaires, and the lighting device 110d is a standing lamp. Any number and types of the lighting devices 110a-d may be present in the environment 101.

For the connected lighting system (connected lighting devices 110a-d), the lighting devices 110a-d may further comprise a wireless transceivers or transmitter/receiver (not shown) for wireless communication according to a wireless communication protocol such as Wifi, Bluetooth, Zigbee, Thread etc. In an example, the radiofrequency signals communicated for the network communication may be used for the RF sensing. Additionally, or alternatively, additional radiofrequency signals may be transmitted/received for the purpose of radiofrequency-based sensing.

The second sensing system 120 is exemplary shown as a vision system 120. The vision system 120 comprises a camera for sensing tasks. The camera may be a 2D video camera, a stereo video camera, a depth-aware (ranging) video camera (e.g., time-of-flight camera). The sensing tasks for the first and the second sensing system may relate to sensing a characteristic of the user 130 in the environment 101 or a characteristic of the environment 101/atmosphere in the environment 101. The sensing tasks may comprise presence detection, motion detection, activity detection, interaction between objects detection, interaction between human & object detection, fall detection, vital sign detection, atmospheric condition detection etc.

A first controller 110 and a second controller 120 may be arranged for controlling the first 110a-d and the second sensing system 120 respectively. In the exemplary figure, the first controller 110 is a lighting controller and shown external to the lighting devices 110a-d, whereas the second controller 120 is shown to be integrated in the second sensing system 120. This choice is not unique, and the first controller 110 may be integrated in one or more lighting devices 110a-d, and/or the second controller 120 may be external to the second sensing system 120.

The first sensing system 110a-d may be of a different type than the second sensing system 120. For example, the first sensing system 110a-d may comprise a radiofrequency-based sensing system arranged for sensing for instance presence of a user 130 in the environment 101. The second system 120 may also be arranged for sensing the presence of the user 130 but uses a vision-based sensing system for instance a camera 120 for the presence sensing. The first 110a-d and the second 120 sensing system may have at least a partially overlapping sensing range such that in the at least partially overlapping sensing range both sensing systems e.g., detects the presence of the user 130.

The first controller 110 may be further arranged for controlling a first actuation system which can affect, at least in a subzone of the environment, the sensing from the second sensing system. In the exemplary figure, the actuation devices are the lighting devices 110a-d. In an example, the first sensing system 110a-d and the first actuation system 110a-d are co-located. The sensing and the actuation may be performed by the same device, e.g., the lighting device 110a-d (e.g., sensing via the integrated wireless transceivers or transmitter/receivers). In other words, the sensing elements (e.g., the wireless communication module) and the actuation elements (e.g., the light source) may be comprised in the same device or housing.

The light emitted by the lighting devices 110a-b can affect the second sensing system, e.g., the vision-based system 120. The performance of camera sensing 120 may be seriously deteriorated when the lighting devices 110a-d are not providing sufficient illumination for illuminating the environment 101. Alternatively, a glare, a shadow, or high intensity light may also negatively affect the sensing performance of the camera sensing 120. A lighting effect can also affect the performance of the camera sensing effect by the lighting effect keeping the human away from the camera (e.g., if the area in the camera's FOV is only dimly lit, the elderly will not sit there).

The lighting infrastructure is known to introduce EMI into the built environment depending on the environment of installation and the product. In many commercially available sensors designs the influence of EMI on the sensing performance is neglected. For instance, as the touch sensing devices are getting thinner (fewer or thinner substrates) and capacitive touch sensing technologies are getting implemented in a growing number of new environments, new challenges arise for the robustness of touch sensors. It is known that many highly sensitive touch sensors face challenges with insufficient EMI (Electromagnetic interference) immunity levels.

A capacitive display may be mounted on the wall right next to a high-power lighting fixture providing an up-lighting effect to the ceiling or a high-intensity colored wall grazing light effect. This specific touch screen design deployed in the room may exhibit a low immunity level to EMI noise. Capacitive touch sensors are for instance influenced by conductive coupling (this occurs when the lights and the victim touch display are connected with direct contact through a wire). The conducted EMI is naturally the most important noise to capacitive touch sensors.

In addition, touch sensors may be affected by inductive coupling (occurs when a varying magnetic field of e.g., the LED driver causes a change in voltage on the victim touch display), Capacitive coupling (occurs when a varying electrical field causes a change in voltage on the victim touch display) and Radiative coupling (occurs when the distance of the LED driver and the victim capacitive display is typically more than a wavelength and the LED light emits electromagnetic waves that are received by the victim LED display that acts as antenna.)

WiFi sensing is well known to be able to perform fine-grained gesture recognition. For instance, WiFi sensing can recognize from a distance the typed letters when the user is typing with his fingers on a keyboard by using merely a commodity WiFi chip. In an example, when the first lighting system receives a request to adjust the actuation of the lighting system (e.g., to minimize the EMI emissions of the lighting fixture and thereby improve the touch/gesture sensing accuracy of the nearby-mounted capacitive touch display), the second controller to hand over, at least partially, the gesture detection of the user's hand with WiFi sensing performed by the lights. The hand over may be a complete hand over such that the user's hand is completely detected by the Wifi sensing instead of performing touch/gesture detection via the capacitive and/or radar sensors of the LCD display

In another example, the first sensing system may be flush mounted in a first wall box and second sensing system may be flush mounted in a second wall box. The first and second wall box may be arranged in a 2-gang arrangement. Hence, the first sensing system and second sensing system are very close to each other and hence may interfere with each other. For instance, the first sensing system may be embedded in a phase-cut dimmer module which may cause EMI or harmonics disturbing the second sensing system, especially if the phase cut dimmer is operated at a low dimming level. Please note that the phase-cut dimming module features a WiFi radio which is used for home automation but can also perform WiFi sensing. The second sensing system may be a radar system which is disturbed by the EMI emissions of the phase cut dimming system.

In a further developed embodiment, the actuation of the lighting device at maximum light output level may involve the actuation of an active cooling device integrated in the lighting device e.g. a fan integrated in a high punch spotlight. The noise of the active cooling device will however deteriorate the audio sensing of the other sensing system located in proximity of the lighting device. Similarly, the fan may lead to mechanical vibrations affecting the non-lighting sensing system.

Similarly, transitions in the light output of the lighting device may lead to mechanical stress in the lighting system leading to audio noise (e.g. cracking noise) or vibration events whenever the mechanical stress induced by the temperature transition of the lighting fixture relaxes. These audio/vibration events can disturb the other sensing system. Similar, the thermal gradient induced by an actuated lighting device may lead to mechanical stress at the location of the other sensor, which may lead to deterioration of the sensing performance of the non-lighting sensing system located in the vicinity of the lighting fixture.

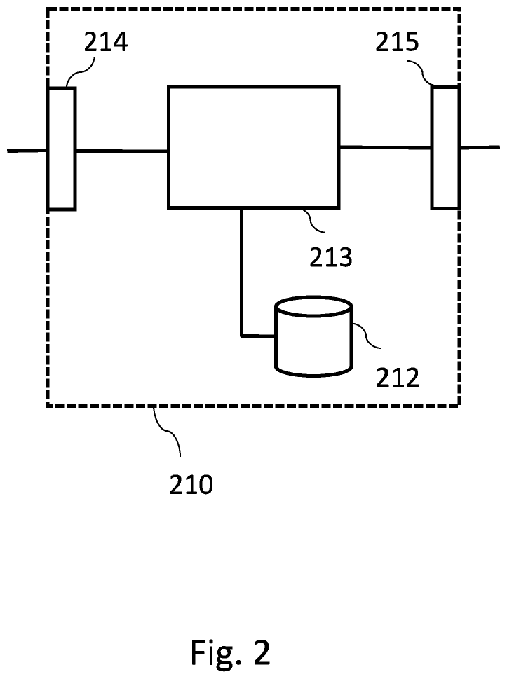

FIG. 2 shows schematically and exemplary an embodiment of a controller 210 for sensing in an environment via a first 110a-d and a second sensing system 120. In an example, the controller 210 is comprised in the first controller 110 or vice versa, e.g., the first controller 110 is the controller 210, and the notation of the controller 210 and the first controller 110 can be used interchangeably. In another example, the controller 210 may be comprised in the second controller 120 or vice versa.

The controller 210 may comprise an input unit 214 and an output unit 215. The input 214 and the output 215 units may be comprised in a transceiver (not shown) or input 214 may be comprised in a receiver and the output 215 is comprised in a transmitter, arranged for receiving (input unit 214) and transmitting (output unit 215) radio frequency signals or any wireless signal for communicating with the first 110 and/or the second controller 120 according to any suitable wireless communication protocol such as Bluetooth, Zigbee, Wifi, Thread etc. The input 214 and the output unit 215 may be arranged for wired communication according to any suitable wired communication protocol such as power-over-ethernet, power-line communication etc.

The controller 210 may further comprise a memory 212 which may be arranged for storing communication IDs of the first controller 110, the second controller 120, the lighting devices 110a-d, and/or of any actuation/sensing device. The controller 210 may comprise a processor 213 arranged for executing or at least controlling the execution of the steps of the method according to the first aspect.

The controller 210 may be implemented in a unit separate from the first controller 110, the second controller 120, the lighting devices 110a-d, and the user device 131, such as wall panel, desktop computer terminal, or even a portable terminal such as a laptop, tablet or smartphone. Alternatively, the controller 210 may be incorporated into the same unit as the first controller 110, the second controller 120, the user device 131, and/or the same unit as one of the lighting devices 110a-d. Further, the controller 210 may be implemented in the environment 101 or remote from the environment 101 (e.g. on a server); and the controller 210 may be implemented in a single unit or in the form of distributed functionality distributed amongst multiple separate units (e.g. a distributed server comprising multiple server units at one or more geographical sites, or a distributed control function distributed amongst the first controller 110, the second controller 120, the user device 131, the lighting devices 110a-d. Furthermore, the controller 210 may be implemented in the form of software stored on a memory (comprising one or more memory devices) and arranged for execution on a processor (comprising one or more processing units), or the controller 210 may be implemented in the form of dedicated hardware circuitry, or configurable or reconfigurable circuitry such as a PGA or FPGA, or any combination of these.

To enable the controller 210, for example, to receive or transmit communication signals, the communication may be implemented in by any suitable wired or wireless means such as a local (short range) RF network, e.g., a Wi-Fi, ZigBee, Bluetooth or Thread network, Power-over-Ethernet, power-line communication or any combination of these and/or other means.

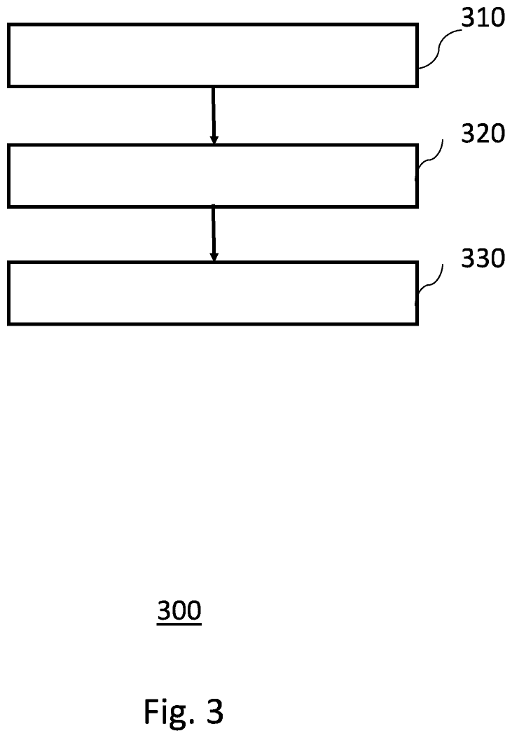

FIG. 3 shows schematically and exemplary a flowchart illustrating an embodiment of a method 300 for sensing in an environment 101 via a first 110a-d and a second sensing system 120. A first controller 110 and a second controller 120 may be arranged for controlling the first 110a-d and the second sensing system 120 respectively. The first 110 and the second controller 120 may be integrated in the sensing system/devices 110a-d, 120 or alternatively may be external to the sensing system/devices 110a-d, 120.

The first sensing system 110a-d is of a different type than the second sensing system 120. The different type may comprise the same sensing tasks, e.g., presence sensing, performed via a different sensing mechanism, for instance via camera-based sensing vs. radiofrequency-based sensing. The different type may comprise different sensing tasks.

The first sensing system 110a-d may at least have a partially overlapping sensing range with the second sensing system 120. Therefore, for instance, in at least one subzone of the environment 101, the first 110a-d and the second sensing system 120 detects the same sensing event (e.g., via a different sensing mechanism).

The first controller 110 may be further arranged for controlling a first actuation system 110a-d which can affect, at least in a subzone of the environment 101, the sensing from the second sensing system 120. The first actuation system 110a-d and the first sensing system 110a-d may be co-located. In another example, the first actuation system 110a-d and the first sensing system 110a-d may be performed by the same system or the same devices. The at least one subzone may (at least partially) overlap with the at least partial sensing range of the two sensing systems 110a-d, 120. In an example, the second controller 120 may also be arranged for controlling a second actuation system (not shown).

In an example, the first controller 110a-d may be arranged for controlling a lighting system 110a-d comprising at least one lighting device 110a-d for providing illumination in the environment 101 and a radiofrequency-based sensing, and wherein the second controller 120 is arranged for controlling a vision-based sensing system, wherein the radiofrequency-based sensing has at least a partially overlapping sensing range with the vision-based sensing 120, and wherein the lighting illumination can affect the vision-based sensing system 120 at least in a subzone of the environment 101.

The method 300 may comprise receiving 310, at the first controller 110, a request for an interaction from the second controller 120, wherein the request comprises adjusting the actuation of the first actuation system 110a-d to minimize the effect of the first actuation system 110a-d on the sensing of the second sensing system 120. The first actuation system 110a-d may positively or negatively impact the sensing from the second sensing system 120. In another example, the first actuation system 110a-d may also affect the sensing of the first sensing system 110a-d. The second controller 120 may determine the effect of the first actuation system 110a-d on the sensing of the second sensing system 120. The determination may be precise such as providing a probability of false positives/precision lost etc. or may be a crude estimation of the effect for instance whether or not the first actuation system 110a-d affects the second sensing system 120. Additionally, or alternatively, the first controller 110 may determine the effect of the first actuation system 110a-d on the sensing of the second sensing system 120. The first 110a-d and/or the second sensing system 120, based on e.g., how the determination of the effect is made, may have a threshold beyond which the second controller 120 is arranged for requesting the first controller 110 for adjusting the actuation of the first actuation system 110a-d to minimize the effect of the first actuation system 110a-d on the sensing of the second sensing system 120.

The second controller 120 may communicate with the first controller 110 using any wireless and/or wired communication means using suitable/appropriate wireless/wired communication protocol. The first 110 and the second controller 120 comprise the appropriate circuitry (not shown) to perform the wireless/wired communication. In an example, the second controller 120 directly communicates the request to the first controller 110. Additionally, or alternatively, the second controller 120 may communicate the request to the first controller 110 via the user device 131 or any other device/means.

The method 300 may further comprise assigning 320 a priority value to the received request indicative of a level of priority of the received request. The method 300 may further comprise assigning 320 priority value based on one or more of the request of interaction, a characteristic of the requested interaction with the second controller 120, a characteristic of the second controller 120.

In an example, the characteristic of the second controller 120 may comprise a trustworthiness property, and wherein the method 300 may further comprise assigning a trustworthiness value indicative of a level of trustworthiness of the second controller 120, and wherein priority value is assigned based on the trustworthiness value.

Additionally, or alternatively, the method 300 may further comprise assigning 320 priority value based on the sensing tasks and/or the sensing outcome of the second sensing system 120. Yet additionally, or alternatively, the method 300 may further comprise assigning 320 priority value based on an environment 101 related contextual information.

The method 300 may further comprise determining 330 whether to accept the request of adjusting the actuation based on the assigned priority value. The method 300 therefore allows the first controller 110 to make a decision of accepting or rejecting the request of adjusting the first actuation system 110a-d. The first 110 and the second controller 120 may be arranged in a master-slave configuration such that the second controller 120 may be a master controller and therefore a priority is assigned to the request from the second controller 120. Or in other words, the first controller 110 as being a slave controller 110 (always) accepts the request of the second controller 120.

Alternative to the master-slave configuration, the first 110 and the second controller 120 may have equal rights or may be no rights are defined. For example, the first 110 and the second controller 120 may be from different manufacturers, vendors, and in general may not know any priority ranking within the environment and further may not know the working (e.g., machine learning algorithms) of each other.

If the determination 330 results in an acceptance of the request, the method 300 may further comprise adjusting the actuation of the first actuation system 110a-d based on the request. The adjustment may be determined 330 by the first controller 110 and/or by the second controller 120. The adjustment is determined such that the (negative) effect of the first actuation system 110a-d on the sensing of the second sensing system 120 is minimized/removed.

If the determination 330 results in a rejection of the request, the method 300 may further comprise requesting the second controller 120 to hand over, at least partially, a sensing task of the second sensing system 120 to the first sensing system 110a-d in the at least partially overlapping sensing range.

Additionally, or alternatively, if the determination 330 results in a rejection of the request, the method 300 may further comprise requesting the second controller 120 to perform a joint sensing in the at least partially overlapping sensing range.

In an example, before the first controller 110 is proposing to take over the sensing from the second controller 120, the first controller 110 may check the user's 130 respective past usage of the first 110a-d and the second sensing system 120 mobile application on user's mobile 131 respectively, and/or whether currently the first 110a-d and/or the second sensing system 120 mobile application are open on the user's mobile device 131. If the user uses the first sensing system 110a-d mobile application more frequently or if the first sensing system 110a-d mobile application is open now while the second sensing system 120 mobile application is closed, the first controller 110 may share these insights with the second controller 120 and reasons the first controller 110 should take over the sensing as the first sensing system 110a-d mobile application is (currently) better suited to provide feedback to user 130 about the insights of the sensing.

In an example, the first controller 110 may be arranged to operate in an explainable mode and an unexplainable mode, and the first controller 110 in the explainable mode may be arranged for transmitting explainability information to the second controller 120 related to control decisions of the first controller 110. In an example, the second controller 120 may also be arranged for, for instance in the explainable mode, transmitting explainability information to the first controller 110. The first 110 and the second controller 120 may comprise or be arranged for using machine learning models to determine at least some of the control decisions for controlling the respective actuation and/or sensing system. A machine learning model may comprise a mathematical function or representation of a relationship between input(s) and output(s). A model is the result of a machine learning algorithm applied to a training data set. A model is often a parametrized mathematical formula, where parameters are learned by a machine learning algorithm. Given input data, a model can produce a classification label or a regression value directly, or it can produce a probability for each possible value (input).

The explainability information may comprise information related to the determination of control decisions by the machine learning model, e.g., how machine learning model works and why a particular control decision is determined by the machine learning model. For instance, based on the raw data how sensing system comes to a conclusion about the sensing event. The explainability information may comprise transparency and/or interpretability information related to the determination of control decisions and of the machine learning models. The explainability information provides understanding of the machine learning models and the control decisions determined by the models. For example, the information may comprise the extent to which a cause and effect can be observed within an actuation and/or sensing system. Or, to put it another way, it is the extent to which it can be predicted what is going to happen, given a change in input or machine learning algorithmic parameters. Additionally, or alternatively, the information may comprise the extent to which the internal mechanics of a machine learning model can be explained in human-like terms. The transfer of explainability information to the second controller 120 may help the second controller 120 understands why a particular control decision is taken by the machine learning model of the first controller 110. In an example, the explainability information needs not to be necessarily in a human-like terms since the information is shared with the second controller 120 and not directly with a user 130. The information may be shared to the user 130 via the second controller 120. Alternatively, the information may be shared with both the second controller 120 and to a user 130 or only to the user 130.

In an example, as part of the negotiation process, the first controller 110 may propose to the second controller 120 to evaluate their respective sensing performances before making a final decision on how to re-allocate the sensing tasks. The evaluation may be performed by co-sensing in parallel (e.g., both WiFi sensing by the first sensing system 110a-d and optimal computer vision-based sensing by the second sensing system 120 at same time). Alternatively, the sensing may be performed in A/B mode (for Monday and Wednesday the second sensing system 120 does all the lighting control based on its computer vision sensing data and on Tuesday and Thursday the first sensing system 110a-d does all lighting controls. At the end of the week, the first 110 and the second controller 120 jointly assess which one of the two sensing scenarios worked more satisfactory for the user 130. Based on these findings, the two systems re-configure the co-sensing in the environment 101.

Before making its proposal for the co-sensing in the room, the first controller's 110 machine learning model may identify which type of nodes/number of sensing nodes the second controller 120 machine learning model can use for e.g., the context awareness sensing of the environment 101. The first controller 110 machine learning model then may estimate whether the first controller 110 or the second controller 120 is actually in the position to make a better decision. For instance, for a first room in the environment 101, the second controller 120 has access to two camera devices while the first sensing system 110a-d may have smaller number of sensing nodes in the same room for optimum performance. Hence, the first controller 110 will honour the original request of adjustment of the lighting actuation from the second controller 120 and will not propose to do co-sensing. However, for a second room in the environment 101 with much furniture, the second controller 120 has access to one single camera while the first sensing system 110a-d has WiFi lamps in the same room ensuring an optimum WiFi sensing performance. Hence, the first controller 110 will propose to do co-sensing and take over the sensing task from the second sensing system 120. In this example, as discussed above, the priority value may be assigned based on the contextual information of the environment 101 and/or the available sensing resources for the sensing systems.

Additionally, or alternatively the first actuation system 110a-d may be rendering a light scene comprising of multiple lights, and the second controller 120 may request to adjust the light setting of a subset of the lighting devices 110a-d. However, the first controller 110 may decide that instead of honouring the original request of the second controller 120, a better alternative is that the real-life lighting setting of the room is purposefully chosen such that
a first portion of the room can be monitored by the computer-vision AI running on the second controller 120
at the same time the lights in a second portion of the room are still displaying their original deep-dimming lighting setting which hampers the second controller's 120 computer vision. To compensate for the compromised computer vision of the second sensing system 120, the lighting system configures the RF sensing of the lighting system to optimally monitor the second portion of the room.
The lighting system 110a-d in a third portion of the room may be configured such that the third portion can be monitored by the combination of a sub-optimal second sensing system's computer vision paired with sub-optimal first sensing system's RF sensing. However, by fusing the two sensor modalities in the third portion of the room, a sufficient overall sensing performance may be achieved.

Hence, in this example, the first sensing system 110a-d and the second sensing system 120 jointly orchestrate the interplay between light settings, the computer-vision performance in different regions of the room by the second controller 120, the RF sensing performance of the lighting devices 110a-d in different regions of the room and the human-centric lighting experience of the user 130.

In an example, the second actuation system of the second controller 120 may affect the first sensing and/or first actuation system 110a-d. For instance, actuation the second sensing system 120 e.g., a home monitoring camera may have its own flood light-source (a second actuation system) which it controls independently of the sensing system 120. However, the second controller 120's flood light may for instance negatively affect a first actuation (lighting) system 110a-d ‘Welcome Home lighting scene’ in the garden when the user 130 approaches the home. In this case, the first controller 110 gets in contact with the second controller 120 to coordinate on how the second sensing system's camera actuation of its light could fit into the total garden lighting experience for the user 130. For instance, the first controller 110 may request from the second controller 120 to use for its monitoring task only IR light instead of visible light. However, the IR light has limited sensing range compared to the visible flood light of the second controller 120. The first controller 110 however offers to perform with its garden lights RF sensing in the less well-lit parts of the walkway so that the second controller 120 is notified early about an approaching visitor.

Continuing the example, when the first controller 110 infers that the owner himself approaches the house (e.g., based on geofencing data or activities of daily living insights), the first controller 110 may ask the second controller 120 to only use IR light to not disturb the garden light scene rendered by lighting device of the first actuation system 110a-d. On the other hand, if the second controller 120 despite of first controller's 110 request has reason to believe that a person approaching the house is not the owner but most likely stranger, the second controller 120 will not honor the request of the first controller 110 as the second controller 120 wants to signify to the approaching person with the visible floodlight that he is “on camera”.

In a different example, the second sensing system 120 may comprise AR/VR headsets utilizing computer vision to understand the context of the environment 101 they are operating in. Let's assume that a Metaverse rock band practice is displayed by its headset. The metaverse rock concert consists of a first guitar player, a second drum player (sharing the room with the first player in the real world) and a third bass player (virtually rendered as avatar). The AR/VR headset of the first player uses computer vision to monitor the physical actions of the second player in the room.

However, the AR/VR headset of the first player may not be able to perform its computer-vision sensing task well as first actuation system 110a-d, e.g., entertainment light creates a low-light or overly glary lighting condition for the image sensor of the AR/VR headset.

In such an example, the first controller 110 may negotiates with the second controller 120, e.g., the AR/VR headset about the light settings of the first actuation system (the lighting system 110a-d) to improve AR/VR computer vision to better understand the context of the room. Specifically, the second controller 120 and the first controller 110 agree for instance for which regions of the room and/or which human activities the computer vision of the AR/VR headset is taking care of vs. in which room regions the WiFi/radar sensing of the first sensing system 110a-d takes care of the context awareness sensing. For example, the first sensing system 110a-d may take care of emotion detection of the second drum player (via monitoring his vital signs) while the computer vision takes care of monitoring his large body movements only. Based on the agreement, the first controller 110 then adjusts the lights in the regions to be monitored by the AR/VR headset accordingly.

The method 300 may be executed by computer program code of a computer program product when the computer program product is run on a processing unit of a computing device, such as the processor 213 of the controller 210.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method of sensing in an environment via a first and a second sensing system, wherein a first controller and a second controller are arranged for controlling the first and the second sensing system respectively, and wherein the first sensing system is of a different type than the second sensing system, and wherein the first sensing system has at least a partially overlapping sensing range with the second sensing system,
wherein the first controller is further arranged for controlling a first actuation system which can affect, at least in a subzone of the environment, the sensing from the second sensing system,
wherein the method comprises:
receiving, at the first controller, a request for an interaction from the second controller, the interaction comprising the actuation of the first actuation system affecting, at least in the subzone of the environment, the sensing from the second sensing system, wherein the request comprises adjusting, by the first controller, the actuation of the first actuation system to minimize the effect of the first actuation system on the sensing of the second sensing system,
assigning a priority value to the received request indicative of a level of priority of the received request,
determining whether to accept the request of adjusting the actuation based on the assigned priority value.

2. The method according to claim 1, wherein if the determination results in an acceptance of the request, the method further comprises adjusting the actuation of the first actuation system based on the request.

3. The method according to claim 1, wherein if the determination results in a rejection of the request, the method further comprises requesting the second controller to hand over, at least partially, a sensing task of the second sensing system to the first sensing system in the at least partially overlapping sensing range.

4. The method according to claim 1, wherein if the determination results in a rejection of the request, the method further comprises requesting the second controller to perform a joint sensing in the at least partially overlapping sensing range.

5. The method according to claim 1, wherein the first controller is arranged for controlling a lighting system comprising at least one lighting device for providing illumination in the environment and one or more of a radar, a time of flight, ToF, sensing, a radiofrequency-based sensing, and wherein the second controller is arranged for controlling a vision-based sensing system, wherein one or more of the radar, the ToF, the radiofrequency-based sensing has at least a partially overlapping sensing range with the vision-based sensing, and wherein the lighting illumination can affect the vision-based sensing system at least in a subzone of the environment.

6. The method according to claim 1, wherein the method further comprises assigning priority value based on one or more of: the request of interaction, a characteristic of the requested interaction with the second controller, a characteristic of the second controller, a number and/or type of the sensing devices for the second sensing system.

7. The method according to claim 1, wherein the method further comprises assigning a trustworthiness value indicative of a level of trustworthiness of the second controller, and wherein priority value is assigned based on the trustworthiness value.

8. The method according to claim 1, wherein the method further comprises assigning priority value based on the sensing tasks and/or the sensing outcome of the second sensing system.

9. The method according to claim 1, wherein the method further comprises assigning priority value based on an environment related contextual information.

10. The method according to claim 1, wherein the method further comprises determining whether to accept the request of adjusting the actuation further based on a user's past interaction or preference with the first and the second controller.

11. The method according to claim 1, wherein the determination of whether to accept the request of adjusting the actuation is further based on sensing performance of the first and the second sensing system at least in the subzone of the environment.

12. The method according to claim 11, wherein the sensing performance is evaluated based on a number of sensing devices of the first and/or the second sensing system, historical performance of the first and the second sensing system, layout of the subzone of the environment, physical objects in the subzone of the environment, sensing interference in the subzone of the environment.

13. A controller arranged for controlling a first sensing system in an environment, wherein the first sensing system has at least a partially overlapping sensing range with a second sensing system,
wherein the controller is further arranged for controlling a first actuation system which affects, at least in a subzone of the environment, the sensing from the second sensing system, and wherein the first sensing system is of a different type than the second sensing system, and wherein the first sensing system has at least a partially overlapping sensing range with the second sensing system,
wherein the controller comprises a processor arranged for executing the steps of:
receiving a request for an interaction from the second controller, the interaction comprising the actuation of the first actuation system affecting, at least in the subzone of the environment, the sensing from the second sensing system, wherein the request comprises adjusting, by the first controller, the actuation of the first actuation system to minimize the effect of the first actuation system on the sensing of the second sensing system,
assigning a priority value to the received request indicative of a level of priority of the received request,
determining whether to accept the request of adjusting the actuation based on the assigned priority value.

14. A system for sensing in an environment via a first and a second sensing system, wherein a first controller and a second controller is arranged for controlling the first and the second sensing system respectively, and wherein the first sensing system is of a different type than the second sensing system, and have at least a partially overlapping sensing range with the second sensing system,
wherein the first controller is further arranged for controlling a first actuation system which affects, at least in a subzone of the environment, the sensing from the second sensing system,
wherein the system comprises:
the second controller,
a first controller according to claim 13.

15. A computer program product comprising instructions which, when the program is executed by a computer, cause the computer to carry out the steps of the method of claim 1.
